(19) United States
(12) Patent Application Publication
(10) Pub. No.: US 2008/0148506 A1
(43) Pub. Date: Jun. 26, 2008

(54) Automobile Washing Device

(75) Inventor: Pieter Schouten, Berkley, CA (US)

Correspondence Address: BOND, SCHOENECK & KING, PLLC, ONE LINCOLN CENTER, SYRACUSE, NY, 13202-1355, US

(73) Assignee: Carrand Companies, Inc., Compton, CA (US)

(21) Appl. No.: 11/615,625

(22) Filed: Dec. 22, 2006

(51) Int. Cl. B60S 3/04

(52) U.S. Cl. 15/118; 15/210.1

(57) ABSTRACT

An automotive washing system generally including a handle, a wash implement, and a wash implement retaining material that securely and releasably interconnects the handle to the wash implement. The handle includes a gripper portion that is generally orb-shaped so as to ergonomically conform to a user's hand. The wash implements can be composed of a variety of fabrics useful is washing, polishing, buffing, and waxing an automobile.

This application claims priority to U.S. patent application Ser. No. 29/275,165, filed Dec. 15, 2006.

### BACKGROUND OF THE INVENTION

1. Field of the Invention

The present invention relates generally to automotive washing systems, and more particularly to hand held washing devices.

2. Description of the Related Art

Automobiles are traditionally washed using a sponge or similar fabric cloth that have been soaked in a bucket of soapy water. The sponge is held by the washer and manually moved over the surface of the automobile such that dirt and other debris can be removed from the surface. Use of the sponge is sometimes supplemented with a slightly more abrasive fabric material, such as a sponge with a mesh netting or microfiber, that may be used to remove more adhered debris, such as bugs, bird excrement, or other undesirable substances.

Once the automobile has been scrubbed with the sponge and soapy water, it is then rinsed with clean water and dried. Typically a chamois, microfiber, or PVA cloth or similar material cloth is used to dry the automobile in a manner that reduces the likelihood of water streaks remaining on the surface of the automobile.

Once dry, the automobile may then be buffed, polished, and perhaps, waxed using buffing, polishing, or waxing cloths, pads or sponges. Typically, these cloths, like the sponge used to wash the automobile, are hand held by the washer.

While effective for washing automobiles, the typical system explained herein suffers certain drawbacks. For instance, because of the direct contact between the washer's hand and the cloths used to clean, oils, dirt, among other things, can be transferred from the washer's hand to the cloth (and vice versa, which gets the washer's hands dirty), and ultimately to the automobile, thus partially defeating the purpose for having washed the automobile. Because the washer's hands are involved in holding the clean underside, that underside of the cleaning sponge, pad or cloth is precluded from being used. Secondly, while not in use during the cleaning operation, the cloths are generally lying on the pavement or surface where the automobile is parked and pick up the dirt therefrom. Again, this dirt may ultimately be transferred from the cloth to the automobile. Third, depending on the amount and location of pressure applied by the washer and size of cloth being used, it is possible that an uneven wash pattern may result.

### BRIEF SUMMARY OF THE INVENTION

It is therefore an object and advantage of the present invention to provide a hand held washing system that is ergonomic, doesn't utilize direct contact between the washer's hand and the wash implement while washing, and that includes a wide variety of wash implements.

It is another object and advantage of the present invention to provide a washing system that facilitates a substantially even amount of pressure being applied by the wash implement to the automobile's surface.

It is a further object and advantage of the present invention to provide a wash implement or set of wash implements that include two cleaning surfaces.

Other objects and advantage of the present invention will in part be obvious, and in part appear hereinafter.

In accordance with the foregoing objects and advantages, the present invention provides an automotive washing system generally comprising a handle, a wash implement, and a wash implement retaining material that interconnects the handle to the wash implement. In one aspect of the present invention the handle comprises a gripping member and a wash implement engaging member, with the wash implement engaging member comprising a concave shaped, downwardly facing surface. The wash implement is composed of a fabric and the coats the downwardly facing surface of the wash implement engaging member and is adapted to securely and releasably interconnect the wash implement to the wash implement engaging member. In one aspect of the invention, the wash implement engaging member is composed of a hook material.

In another aspect of the present invention a second wash implement is provided with the cleaning system. The wash implements are generally disc shaped and pliable so as to conform to the concave shaped wash implement retaining member. In addition, the peripheral edge region of the wash implement retaining member is preferably pliable so as to flex outwardly when depressed against a surface, such as happens when the device is used to clean an automobile.

### BRIEF DESCRIPTION OF THE DRAWINGS

The present invention will be more fully understood and appreciated by reading the following Detailed Description in conjunction with the accompanying drawings, in which:

FIG. 1 is a perspective view of the automotive washing system with two alternate wash implements shown in exploded relation to the handle;

FIG. 2 is a top plan view of the handle;

FIG. 3 is a front elevation view of the handle;

FIG. 4 is a side elevation view of the handle;

FIG. 5 is a bottom plan view of the handle; and

FIG. 6 is a perspective view of the wash device.

### DETAILED DESCRIPTION OF THE INVENTION

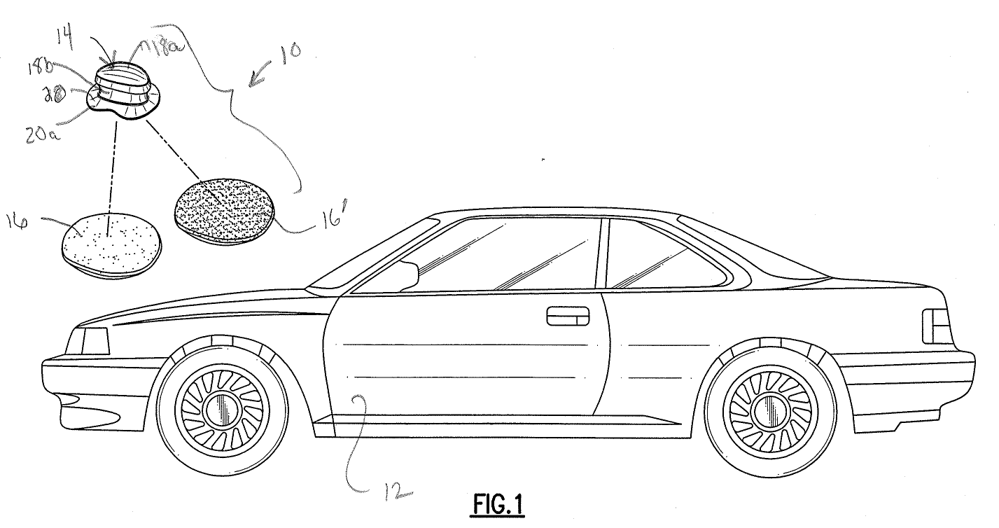

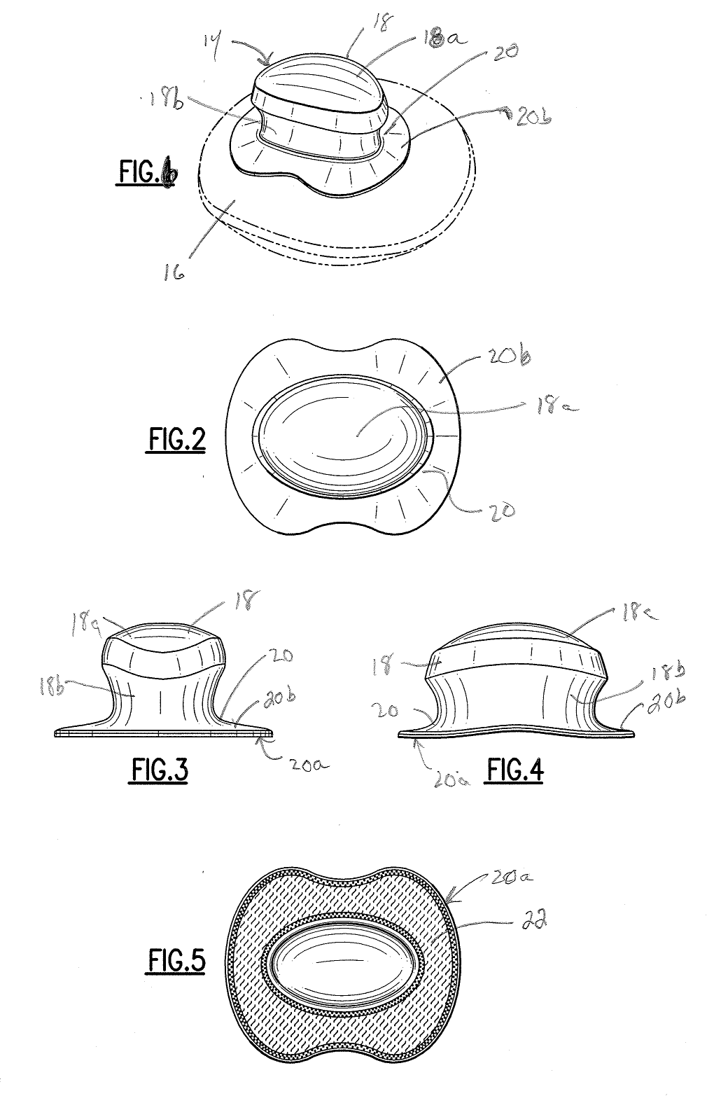

Referring now to the drawings in which like reference numerals refer to like parts throughout, there is seen in FIG. 1 an automotive washing system, referred to generally by reference numeral 10, adapted for use in cleaning an automobile 12. Cleaning system 12 generally comprises a handle 14 and a wash implement 16 that is releasably engagable with the handle 14, as will described in greater detail hereinafter.

Handle 14 is an integral unit comprising a gripping member 18 and a wash implement engaging member 20. Gripping member 18 is preferably orb-shaped that ergonomically conforms with the shape of a user's hand, wherein the orb portion 18a would be seated in the palm of the user's hand, while the user's fingers could securely engage the narrower shaft portion 18b. The wash implement engaging member 20 extends from the narrower shaft portion 18b and includes a conic, concave, parabolic, or other similarly shaped downwardly facing surface 20a and a peripheral edge region 20b. Alternatively, surface 20a could be convex so long as wash implement can contour thereto, the point being that the non-flat surface 20a is more effective at securing the interconnection between wash implement 16 and wash implement engaging member 20. Surface 20a is coated with a wash implement retaining material 22, preferably a hook or post fastener material the gripping characteristics of which are enhanced by the concavity (or convextivity) of the surface 20a, as will be described in greater detail hereinafter.

Wash implement 16 is generally disc shaped with first and second opposing surfaces 16a and 16b. In one embodiment, wash implement 16 is entirely composed of a unitary material, such as chenille, terrycloth (natural cotton), microfiber, and cellular material, or similar fabric, that is useful for safely and gently washing a car's surface. In another embodiment, surface 16a may be composed of one material, such as a chenille, chenille, terrycloth (natural cotton), microfiber, and cellular material, or similarly soft fabric, while the second surface is composed of a more abrasive material, such as nylon mesh or other woven material, that facilitates removal of debris, such as bugs, from the automobile 12. Alternatively, a second wash implement 16′ may be provided that has the same or different washing properties as the wash implement 16. Regardless of the washing function associated with wash implement 16, it is important that both surfaces 16a and 16b be composed of a material that securely, but realeasbly, engages wash implement retaining material 22, such as pile-like or hook-like fabric material.

When using cleaning system 10 a user would hold gripping member 18 and engage a wash implement 16 with surface 20a of wash implement engaging member 20 by pressing downwardly thereby creating tension amongst the hook or post members with the fabric material of wash implement 16. Wash implement 16 may then be used in a traditional washing manner to clean any surface of automobile 12. When cleaning system 10 is pressed downwardly against the surface of automobile 12, the peripheral edge region 20b flexes outwardly to maximize the compressive force translated to wash implement 16. In other words, if peripheral edge region 20b were inflexible only the regions of wash implement 16 directly engaged by the edge of wash implement engaging member 20 would effectively wash automobile 12, whereas if the peripheral edge region 20b flexes outwardly, the majority of wash implement 16 is depressed by downwardly acing surface 20a, thereby effectively washing automobile 12.

Although most shapes would be satisfactory, having wash implement engaging member 20 circular in shape, and wash implement 16 also circular (disc) shaped facilitates an effective combination. Moreover, by having the diameter of wash implement 16 be greater than the diameter of wash implement engaging member 20 other benefits are realized. For instance, such a combination provides an effective amount of washing surface area on implement 16 while minimizing the possibility of wash implement 16 accidentally disassociating from wash implement engaging member 20 while washing automobile 12 due to, among other things, water seeping between implement 16 and downwardly facing surface 20a. Also, this combination all but ensures that the edge of wash implement engaging member 20 is entirely contacted by wash implement 16, thereby preventing wash implement engaging member 20 from directly contacting (and hence scratching) automobile 12 while the automobile 12 is being washed.

What is claimed is:

1. An automotive washing system, comprising:
a. a handle comprising a gripping member and a wash implement engaging member, said wash implement engaging member comprising a downwardly facing surface;
b. a wash implement composed of a fabric; and
c. a first wash implement retaining material coating said downwardly facing surface and adapted to securely and releasably interconnect said wash implement to said wash implement engaging member.

2. The automotive washing system according to claim 1, wherein said wash implement engaging member comprises a peripheral edge region that is pliable.

3. The automotive washing system according to claim 1, wherein said gripping member is orb-shaped to ergonomically conform to a user's hand.

4. The automotive washing system according to claim 1, wherein said first wash implement is disc shaped.

5. The automotive washing system according to claim 4, wherein said wash implement engaging member is circularly shaped and of a first diameter, and said first, disc shaped wash implement is of a second diameter greater than said first diameter.

6. The automotive washing system according to claim 4, wherein said first, disc shaped wash implement includes a first surface composed of natural cotton and a second surface composed of a nylon mesh material.

7. The automotive washing system according to claim 1, wherein said wash implement retaining material is composed of hook material, and said first wash implement is composed of a fabric adapted to securely engage said hook material.

8. The automotive washing system according to claim 1, further comprising a second wash implement.

9. The automotive washing system according to claim 8, wherein said second wash implement is disc shaped.

10. The automotive washing system according to claim 8, wherein said second wash implement includes a first surface composed of natural cotton and a second surface composed of nylon mesh.

11. The automotive washing system according to claim 1, wherein said downwardly facing surface is concave.
